(19) United States
(12) Patent Application Publication
(10) Pub. No.: US 2019/0212172 A1
(43) Pub. Date: Jul. 11, 2019

(54) Absolute Optical Encoders Using Programmable Photodetector Array

(71) Applicant: TT Electronics PLC, Carrollton, TX (US)

(72) Inventors: Brent Hans Larson, Dallas, TX (US); James P. Cusey, Dallas, TX (US)

(21) Appl. No.: 15/980,225

(22) Filed: May 15, 2018

Related U.S. Application Data
(60) Provisional application No. 62/615,243, filed on Jan. 9, 2018.

(51) Int. Cl. G01D 5/347

(52) U.S. Cl. CPC G01D 5/34715

(57) ABSTRACT

An encoder system includes a group of programmable detectors, a group of programmable channels, and a programmable connectivity network coupled between the programmable detectors and the programmable channels. Each of the programmable detectors is operable to produce an electric current in response to an optical or magnetic input. Each of the programmable channels is operable to produce an output in response to an electric current input. The outputs from the programmable channels form at least a part of a code word for determining an absolute position of a motion object. The programmable connectivity network is operable to route electric currents from at least a part of the programmable detectors to each of the programmable channels.

### PRIORITY

This application claims the benefits of U.S. Provision Application Ser. No. 62/615243, filed Jan. 9, 2018, the entire disclosure of which is herein incorporated by reference.

### BACKGROUND

An encoder system, such as an optical encoder, typically includes an electro-mechanical device that detects positional and/or motional information of an object and converts it to analog or digital signals. For example, the object may be a code disk with patterns thereon. When the code disk rotates or slides, light transmitted through or reflected off the code disk carries the positional and/or motional information of the code disk. The light is subsequently received by photodetectors and the information thereon is detected and processed by circuits. The photodetectors and the processing circuits are typically integrated into one device, such as an Application Specific Integrated Circuit (ASIC).

Manufacturers of optical encoders traditionally require different ASICs for different code disks having varying shapes, sizes, and/or configurations. For example, a code disk may be a code wheel or a code strip. Different code wheels may have different radii and different pulses-per-revolution. Different code strips may have different pulses-per-unit-length. Further, a code disk may be transmissive or reflective, and slits on code disks may have different shapes and sizes. To make different encoders in low-to-moderate volume with different code disks, manufacturers need to purchase and maintain a portfolio of different ASICs in low-to-moderate volume. This results in a higher cost and a need of more complex supply chain than would be needed if the same ASIC may be used for multiple different code disks.

Accordingly, improvements in the encoder system are desired.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIGS. 1A, 1B, and 1C illustrate an example transmissive optical encoder with a rotary code disk (i.e., a code wheel), in accordance with some embodiments.

FIG. 2 is an illustration of an example reflective optical encoder with a linear code disk (i.e., a code strip), in accordance with some embodiments.

FIG. 3 shows a schematic view of an encoder system, in part, in accordance with some embodiments of the present disclosure.

FIG. 4 illustrates an example programmable photodetector array, superimposed by a code disk's absolute track, in accordance with some embodiments.

FIG. 5 shows a schematic view of an encoder system, in part, with programmable detectors and programmable connectivity network, in accordance with some embodiments.

FIG. 6 shows an example implementation of a part of a programmable connectivity network, in accordance with some embodiments.

FIGS. 7A, 7B, and 7C illustrate block diagrams of example optical encoder integrated circuits (IC), in accordance with some embodiments.

FIG. 8 illustrates an example of implementing a quadrature-track pixel array together with an absolute-track pixel array, in accordance with some embodiments.

FIG. 9 shows a circuit diagram of an example interpolator resistor ladder that converts programmable detector array's electric currents into analog output with transimpedance amplifiers (TIAs), in accordance with an embodiment.

FIG. 10 illustrates a block diagram of example optical encoder integrated circuits (IC), in accordance with an embodiment.

FIG. 11 shows a flowchart of an example method of determining a detector-to-channel mapping, in accordance with some embodiments.

FIG. 12 shows a flowchart of an example method of operating an absolute optical encoder with programmable detector array, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. Any alterations and further modifications to the described devices, systems, methods, and any further application of the principles of the present disclosure are fully contemplated as would normally occur to one having ordinary skill in the art to which the disclosure relates. For example, the features, components, and/or steps described with respect to one embodiment may be combined with the features, components, and/or steps described with respect to other embodiments of the present disclosure to form yet another embodiment of a device, system, or method according to the present disclosure even though such a combination is not explicitly shown. Further, for the sake of simplicity, in some instances the same reference numerals are used throughout the drawings to refer to the same or like parts.

The present disclosure is generally related to encoder systems and methods thereof, more particularly to optical encoders with a programmable photodetector array, programmable channels, and a programmable connectivity network between the photodetector array and the channels. In an embodiment, the programmable photodetector array, programmable channels, and programmable connectivity network are integrated into one device, such as an ASIC. The ASIC can be programmed to work with different code disks for detecting and encoding positions (and optionally movements) of the code disks to implement absolute encoders, as well as incremental encoders. An absolute encoder is capable of detecting and encoding the absolute position of a code disk, while an incremental encoder is capable of detecting and encoding the position of a code disk relative to its position when the encoder system is powered up. An encoder may have both functions of an absolute encoder and an incremental encoder integrated. The code disks include code wheels and code strips with any suitable configurations, as well as other types of coding apparatuses. Various embodiments of the present disclosure enable the use of a single ASIC design for encoder systems of varying configurations, thus enabling lower costs and a simpler supply chain for manufacturers. For the purposes of simplicity, optical detection with photodetectors is illustrated in the present disclosure. However, principles of the present disclosure are not limited to optical detection and may be applied to other types of electromagnetic or magnetic detection, such as using magnetic detectors for detecting the change in magnetic flux.

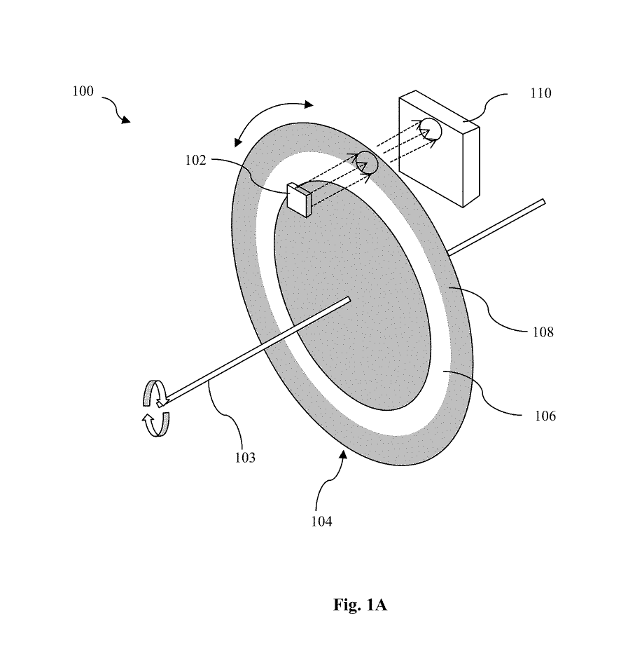

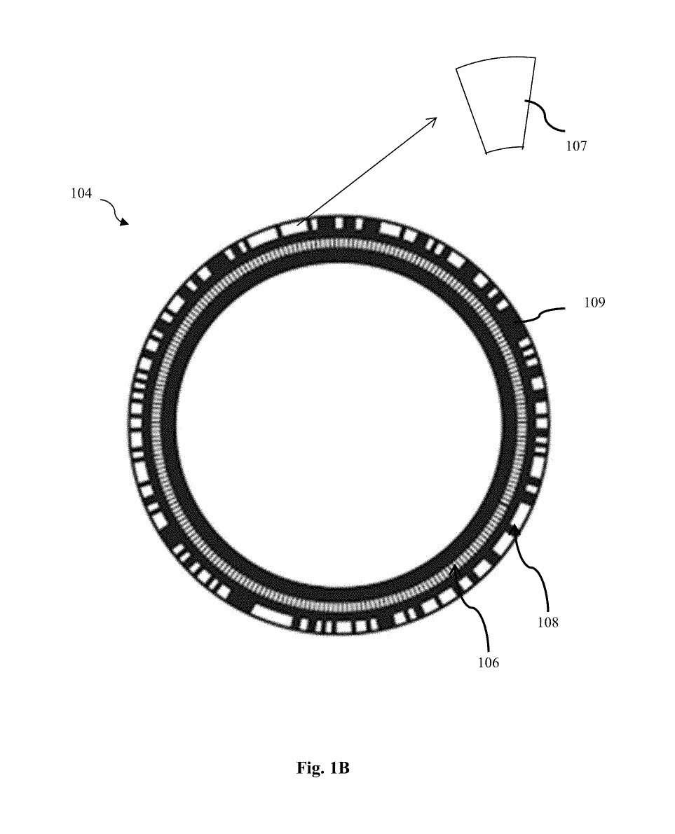

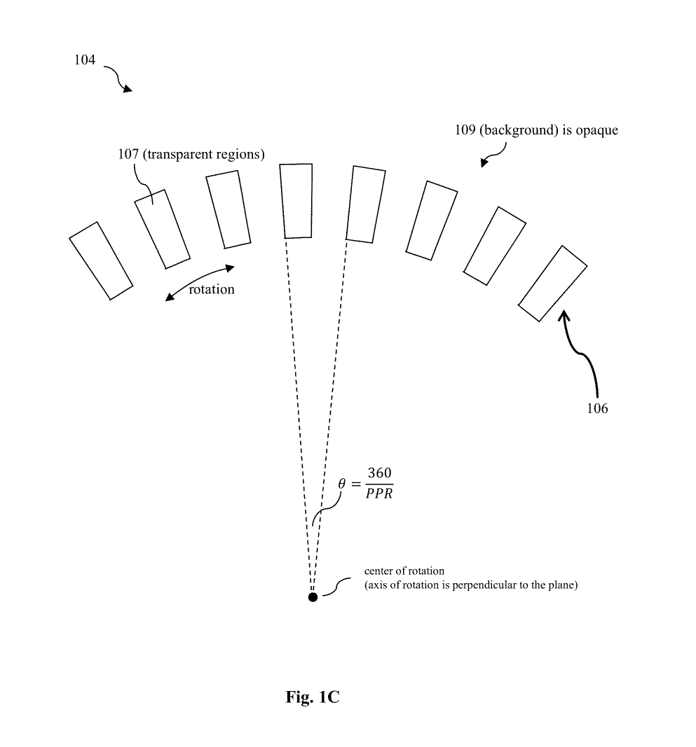

FIG. 1A depicts an embodiment of an encoder system 100 constructed according to the present disclosure. The encoder system 100 includes a light source 102, a code disk 104, and a detector device (or encoder device) 110.

In an embodiment, the light source 102 includes a light emitting diode (LED). In another embodiment, the light source 102 includes a semiconductor laser which produces a coherent light. The wavelength or spectrum of the light produced by the light source 102 works compatibly with the code disk 104 and the detector device 110 which includes various photodetectors in the present embodiment. The light source 102 may further include one or more collimating optics (e.g., in a transmissive optical encoder) or one or more focusing optics (e.g., in a reflective optical encoder).

In the shown embodiment, the code disk 104 rotates around its central axis 103 and is also referred to as a code wheel. The code disk 104 includes one or more tracks with patterns thereon, such as tracks 106 and 108. A track is an annular region on the code disk 104 in this embodiment. Depending on the patterns thereon, a track may be referred to as a quadrature track or an absolute track. For example, a track with alternating and substantially equally sized transmissive and opaque patterns can be used for encoding motions (velocity and/or direction) of the code disk 104, and is therefore referred to as a quadrature track. In contrast, a track with varying sized transmissive and opaque patterns can be used for encoding absolute positions of the code disk 104, and is therefore referred to as an absolute track. Either track 106 or track 108 may be an absolute track. In an embodiment, the track 108 is an absolute track and the track 106 is a quadrature track. In some embodiments, the code disk 104 may include multiple absolute tracks 108.

An example code wheel 104 is depicted in FIG. 1B with a quadrature track 106 as an inner track and an absolute track 108 as an outer track. Referring to FIG. 1B, the code wheel 104 is a transmissive code wheel in this embodiment. Each of the tracks 106 and 108 includes transmissive patterns (or regions) 107 and opaque patterns 109, indicated by the white and dark areas, respectively. The track 106 includes patterns 107 and 109 arranged alternatingly and being substantially equally sized (e.g., their angular widths are within +/−5%). The track 108 includes patterns 107 and 109 having varying sizes. In the present embodiment, the track 108 is designed such that it may be equally divided (in terms of angular width) into N sections and each of the N sections has a unique pattern in the form of a sequence of transmissive and opaque regions. The N sections may physically overlap with each other. These unique patterns are detected and encoded by the detector device 110 to recognize the unique positions of the code disk 104. For example, the absolute track 108 may provide 2048 unique patterns (N=2048) and the detector device 110 may recognize these 2048 unique patterns and encode them into a code word with 12 bits using binary coding, gray coding, or other suitable coding methods. The design of the detector device 110 matches the design of the absolute track 108. For example, if the patterns 107 are pie-shaped, the photoactive areas in the detector device 110 may also be configured to be pie-shaped. Also, the height of the photoactive areas in the detector device 110 may be configured to match the height of the patterns 107. Since there are many ways of designing the patterns 107 and 109 to provide unique patterns, the absolute track 108 can be designed differently even for the same number of (e.g., 2048) unique patterns. Traditionally, this has required different detector devices to match the different absolute tracks, which increases the costs of encoder manufacturers.

In the present embodiment, the detector device 110 is designed to include a programmable photodetector array, programmable channels, and programmable connectivity network. Each programmable channel may provide one bit in a code word. Each photodetector in the programmable photodetector array may be selectively turned ON, OFF, or partially ON. The connectivity network can be programmed to select a part of the programmable photodetector array to map to a particular channel. Such programmability allows the detector device 110 to work with a variety of code disks 104 with different absolute tracks 108, thereby reducing the costs and simplifying inventories for the encoder manufacturers. In various embodiments, the detector device 110 may support any number of code bits up to the number of available programmable channels. The design of the detector device 110 will be further discussed in later sections of the present disclosure.

One parameter of the code disk 104 is pulses per revolution (PPR), which may be defined by the angular pitch “θ” in its quadrature track 106 where PPR=360°/θ, as shown in FIG. 1C. When the code disk 104 rotates, light passing through the track 106 is modulated with a certain waveform, such as a sinusoidal wave, which can be detected by the detector device 110 to determine the velocity and/or direction of the rotation. In various embodiments, the code disk 104 may have either or both of the quadrature track 106 and the absolute track 108. Furthermore, the patterns 107 and 109 may be in various shapes, such as rectangle, square, pie shape, sawtooth shape, curved shape, or other suitable shapes.

In the depicted embodiment of FIGS. 1A, 1B, and 1C, the code disk 104 is a transmissive code wheel that moves angularly between the light source 102 and the detector device 110. In an alternative embodiment, the code disk 104 may be a reflective code disk. In such embodiment, the regions 107 are reflective instead of transmissive and the regions 109 are absorptive of light. Further, the light source 102 and the detector device 110 may be positioned on the same side of the code disk 104. The light source 102 and the detector device 110 may be integrated into one device, on two devices (e.g., two dies) but physically assembled together, or on two separate discrete devices.

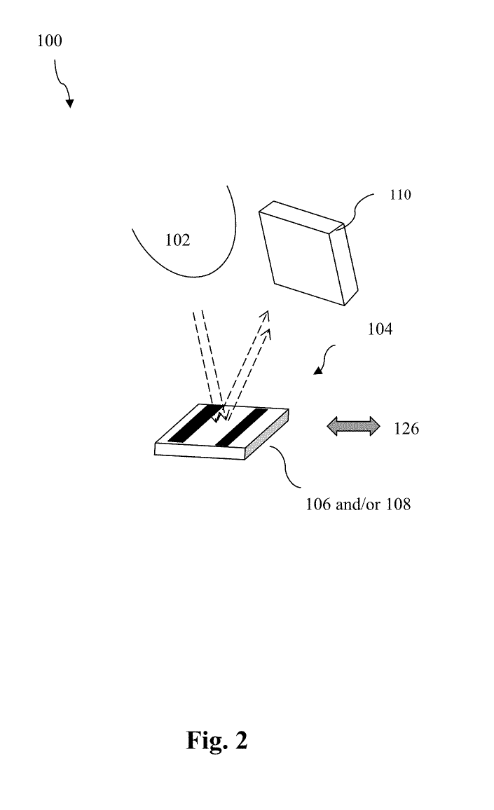

In yet another embodiment, the code disk 104 is a code strip instead of a code wheel. A code strip moves linearly instead of rotating, and can be either transmissive or reflective. FIG. 2 shows an embodiment of the encoder system 100 having a reflective code strip 104. The tracks 106 and 108 on the code strip 104 have various reflective and absorptive regions. The light source 102 and the detector device 110 are on the same side of the code disk 104. Lights reflected off the tracks 106 and 108 are captured by the detector device 110, which then detects and encodes the positions and/or the motion of the code disk 104.

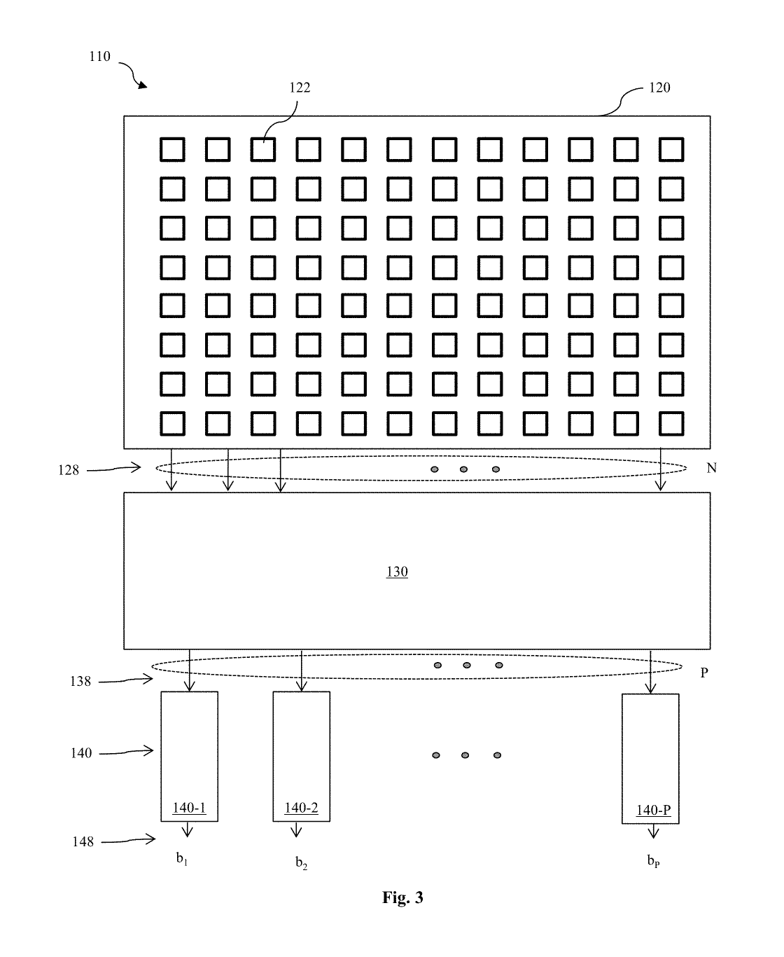

FIG. 3 shows an embodiment of the detector device 110 constructed according to the present disclosure. Referring to FIG. 3, the detector device 110 includes a programmable detector array 120, a programmable connectivity network 130, and multiple channels 140 including channels 140-1, 140-2, . . . and 140-P, where P is an integer greater than 1. The detector array 120 includes a plurality of detectors (e.g., photodetectors) 122 which are arranged to produce N outputs 128, each carrying electric currents. The electric currents change in response to changing lights impinged on the detectors 122. The connectivity network 130 can be programmed to map the outputs 128 to the channels 140. For example, one output 128 may be fed to one or more channels 140, and one channel 140 may take one or more outputs 128. In various embodiments, N is an integer equal to or greater than P. The connectivity network 130 provides P outputs 138 (each is a node within the detector device 110), which also carry electric currents. Each channel 140 is operable to convert the electric currents from the node 138 into an analog voltage signal or a digital (e.g., binary) signal 148. In an embodiment, each channel 140 provides one bit in a code word produced by the encoder system 100. In the shown embodiment, the encoder device 110 produces P bits, bᵢ (i=1. . . P). At least some of channels 140 are programmable. A channel is programmable when some component(s) in the channel is programmable, such as having a programmable threshold, programmable hysteresis, and so on. The detector array 120, the connectivity network 130, and the channels 140 may be implemented using multiple discrete devices or using one integrated device (e.g., an ASIC). The various components of the detector device 110 are further described below.

The programmable detector array 120 includes a plurality of detectors 122. In the present embodiment, each detector 122 is a photodetector. For example, the detector 122 may include a photodiode, a phototransistor, or another suitable photoactive device capable of converting photons into electrons. For purposes of simplicity, a photodetector 122 in the array 120 is also referred to as a photo pixel or a pixel, and the detector array 120 is also referred to as a pixel array. In the present embodiment, the detectors 122 are arranged into regular rows and columns (e.g., 8 rows and 12 columns as shown in FIG. 3). In other words, the detector array 120 is a regular array. In alternative embodiments, the detectors 122 may be arranged into an overall trapezoidal shape (e.g., more detectors at the top than at the bottom), a sparse array, or even an irregular shape. For example, since typical slits of code wheels are pie-shaped, the detectors 122 may be arranged in pie-shaped as well to save die area on the detector device 110. In those embodiments, the collection of the detectors 122 is still referred to as the detector array 120 for the purpose of convenience, even though the overall shape of the collection is not a square or a rectangle. Further, the detectors 122 may be magnetic detectors in some embodiments for detecting magnetic flux changes due to modulation by a code disk.

In an embodiment, each detector 122 can be selectively turned ON or OFF. For example, the detector array 120 may be designed large enough for a variety of code disks 104. For a given code disk 104, not all of the detectors 122 are needed for encoding. Therefore, some of the detectors 122 may be turned off, either to produce better signal quality on the N outputs 128 given the shapes and sizes of the slits in the code disk 104, or to reduce overall power consumption. In another embodiment, each detector 122 can be selectively turned ON, OFF, or partially ON. Setting a detector 122 into partially ON (partial intensity) may allow a weighted current output from the detector, such as a half or quarter pixel to be used, or even zero (i.e., pixel is off). This intensity adjustment may improve the mapping of detectors 122 to match the shapes and sizes of the slits (e.g., a pie-shaped pattern 107) in a code disk 104. In an embodiment, each detector 122 may be programmed independently of others, which provides the maximum programmability of the detector array 120. In another embodiment, some adjacent detectors 122 may be grouped and programmed together. For example, a column or a partial column of detectors 122 may be grouped and programmed together. This reduces the amount of memory that stores the program information. In a further embodiment, electric current outputs from a group of detectors 122 (e.g., a column or a partial column of detectors 122) may be summed together as one output 128.

The shape of detectors 122 may also be made non-homogeneous within the detector array 120 in some embodiments. Having different sizes and/or shapes of the detectors 122 may reduce total system noise. For example, rectangular and grid-based pixels may produce a small amount of noise compared with an ideally shaped detector that better matches the slits (e.g., pie-shaped or sawtooth shaped slits). Adjusting the detectors' shapes to round, elliptical, or having rounded corners may reduce overall noise.

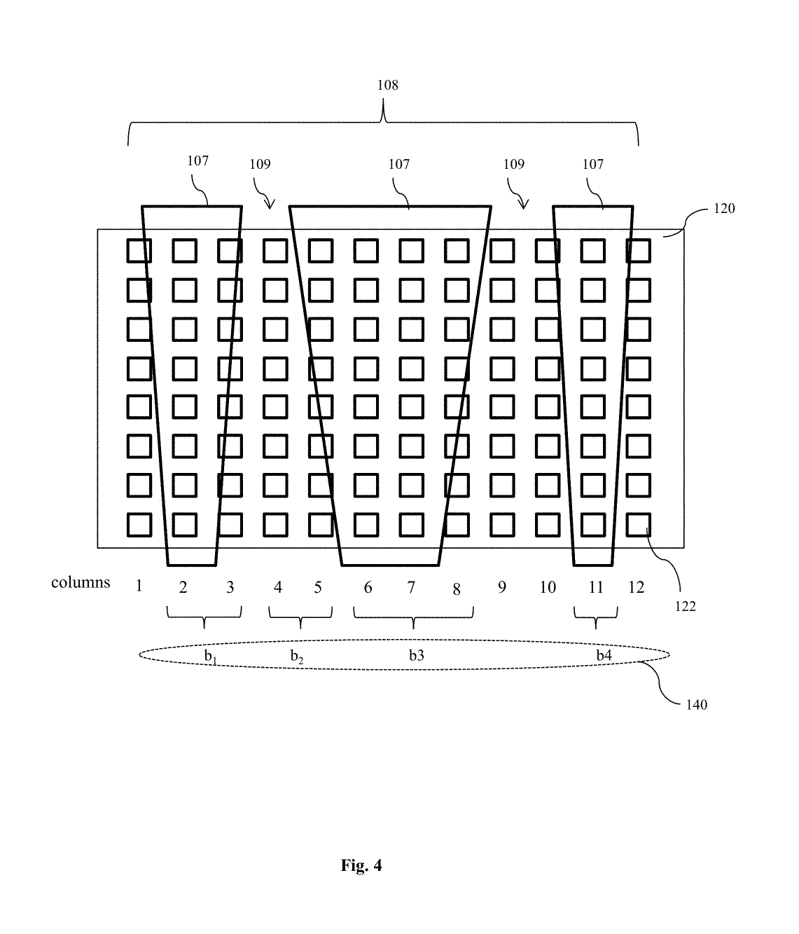

FIG. 4 illustrates one example of mapping (or grouping) detectors 122 to enable a 4-bit absolute encoder, in accordance with some embodiment. It is noted that the number of detectors 122, the number of rows and columns in the detector array 120, and the number of bits (or channels 140) in this example are merely illustrative and do not limit the scope of the present disclosure. Referring to FIG. 4, the detector array 120 includes 8 rows and 12 columns of detectors 122. FIG. 4 further shows the transmissive patterns 107 of the absolute track 108 (FIGS. 1A and 1B) superimposed on the detector array 120. It is noted that the opaque patterns 109 are between the patterns 107. The sequence of the patterns 107 and 109 in this example is one of 16 unique sequences provided by the absolute track 108. According to an example mapping, detectors in columns “1,” “9,” “10,” and “12” are all turned OFF (not used for this encoder implementation), detectors in columns “2” and “3” are mapped to bit b₁ (channel 1), detectors in columns “4” and “5” are mapped to bit b₂ (channel 2), detectors in columns “6, “7,” and “8” are mapped to bit b₃ (channel 3), and detectors in column “11” are mapped to bit b₄ (channel 4). Further, some columns may have some detectors turned ON and some detectors turned OFF, and may even have some detectors turned partially ON. For example, the top four detectors 122 in column “5” may be turned off in an embodiment. All detectors mapped to the same bit have their output electric currents added together, which is processed by the circuitry in the corresponding channel 140. For example, all detectors in columns “2” and “3” (except those turned OFF) supply electric currents to channel “1.” For the given mapping above, the encoder may produce a 4-bit binary code of b[4:1]=“1101” for this particular sequence of patterns 107 and 109. It is noted that the same detector-to-channel mapping must also produce unique codes for the other 15 unique sequences of patterns 107 and 109. In some embodiments, the detector array 120 may be mapped to multiple absolute tracks 108 to support multiple absolute encoding (e.g., to indicate the direction of movement or to increase the resolution of positional coding). For example, one absolute track 108 may be offset from another one by half of a slit width.

As discussed above with respect to FIGS. 1A-1D, the shapes and sizes of the patterns 107 and 109 may vary considerably from a code disk to another code disk. Instead of having different detector array designs for different code disks, the present disclosure uses the same detector array 120 and maps it differently for different code disks 104, particularly different absolute tracks 108. The mapping may be determined using certain software or determined mathematically according to the geometry of the code disk 104, and then stored in a memory module, such as a non-volatile memory. The detector device 110 may read the mapping information along with other information from the memory module upon power up or during operation. This greatly reduces the number of different designs in the detector devices 110 for different code disks, thereby lowering the costs associated with the detector devices 110 thanks to the increased production volume thereof.

Referring back to FIG. 3, the programmable connectivity network 130 is coupled between the detector array 120 and the channels 140. In an embodiment, the connectivity network 130 allows any of the detectors 122 to connect to any of the channels 140. In another embodiment, the connectivity network 130 allows some of the detectors 122 to connect to some, but not all, of the channels 140.

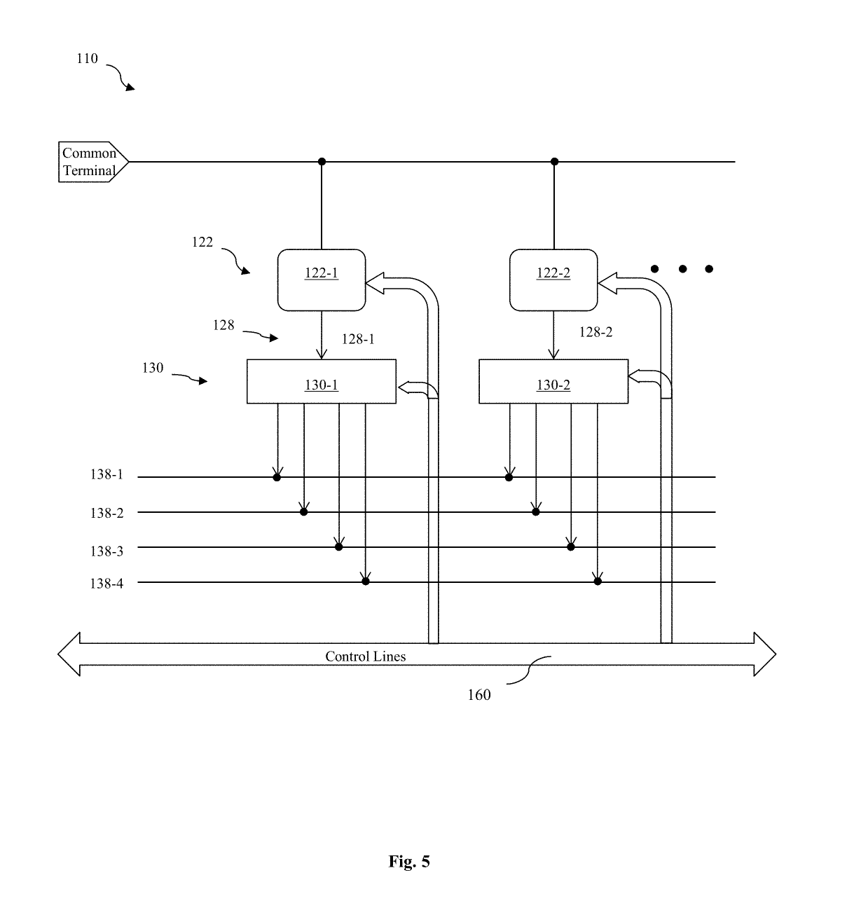

FIG. 5 illustrates an embodiment of the programmable connectivity network 130 connecting (or routing) two detector blocks 122-1 and 122-2 to four channels corresponding to four nodes 138-1, 138-2, 138-3, and 138-4. Each detector block 122-1 and 122-2 may include one detector 122 or a group of detectors 122, such as a column of detectors 122 or multiple columns of detectors 122 in the detector array 120. The two detector blocks 122-1 and 122-2 are coupled between a common terminal and respective nodes 128-1 and 128-2. The common terminal is connected to many detectors or all detectors in the detector array 120 in an embodiment. Each detector in the blocks 122-1 and 122-2 may be turned ON, OFF, or partially ON using the control lines 160. For each detector 122 that is turned ON or partially ON, electric current flows between the common terminal and the respective node 128-1 or 128-2 in proportion to the optical power incident to the photoactive area of the detector 122.

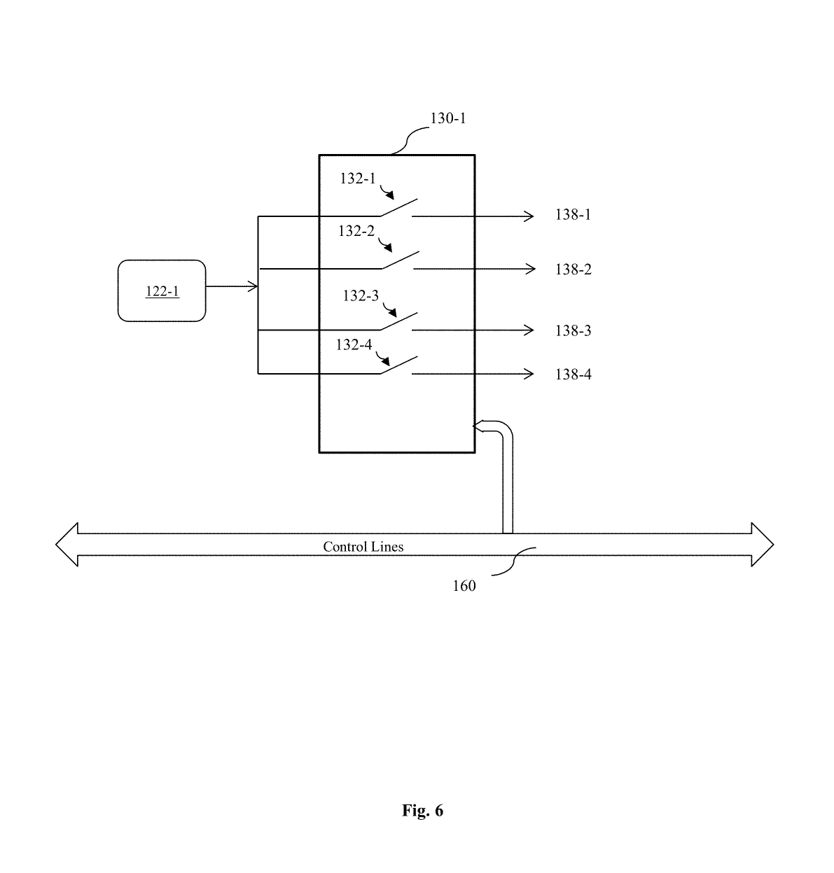

The programmable connectivity network 130 includes a connectivity block 130-1 that connects the detector block 122-1 to any one of the four channels, and a connectivity block 130-2 that connects the detector block 122-2 to any one of the four channels. Each of the connectivity blocks 130-1 and 130-2 may be implemented using multiplexers, switches, transistors, or other suitable circuits. FIG. 6 illustrates an example connectivity block 130-1 implemented using four switches 132-1, 132-2, 132-3, and 132-4. Each of the switches can be programmed by the control lines 160 to either open or close. When a particular switch is closed, the output of the detector block 122-1 is connected (or routed) to the corresponding channel. For example, if the switch 132-2 is closed, the output of the detector connectivity 122-1 is routed to the node 138-2 (subsequently to channel 140-2 of FIG. 3). In an embodiment, both detector blocks 122-1 and 122-2 may be connected to the same node 128-i (i=1, 2, 3, or 4) and their electric currents are summed together. The control lines 160 may be a bus line, a word line in a memory bus, or other suitable structures. The detector device 110 may include other circuitry and connections (not shown) to work in conjunction with the control lines 160, the detectors 122, and the connectivity network 130. For example, the detector device 110 may include a controller to read configuration files from one or more memory modules and to supply the configuration information using the control lines 160 to the various programmable components. The controller may include a microcontroller integrated with the detector array 120 or a standalone microcontroller.

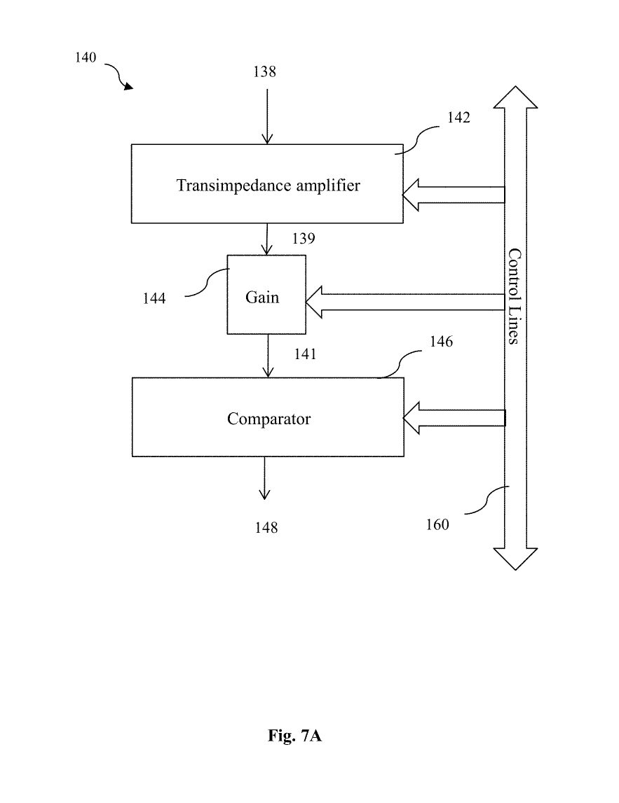

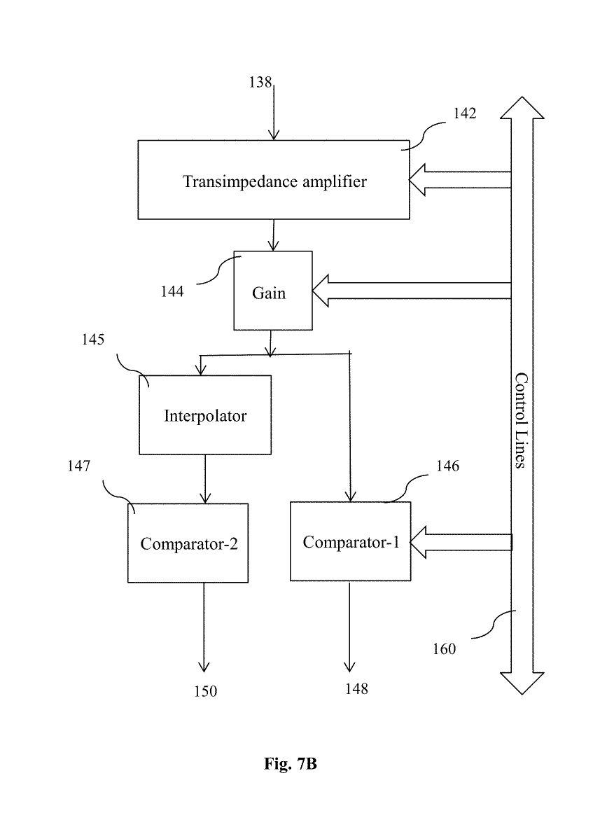

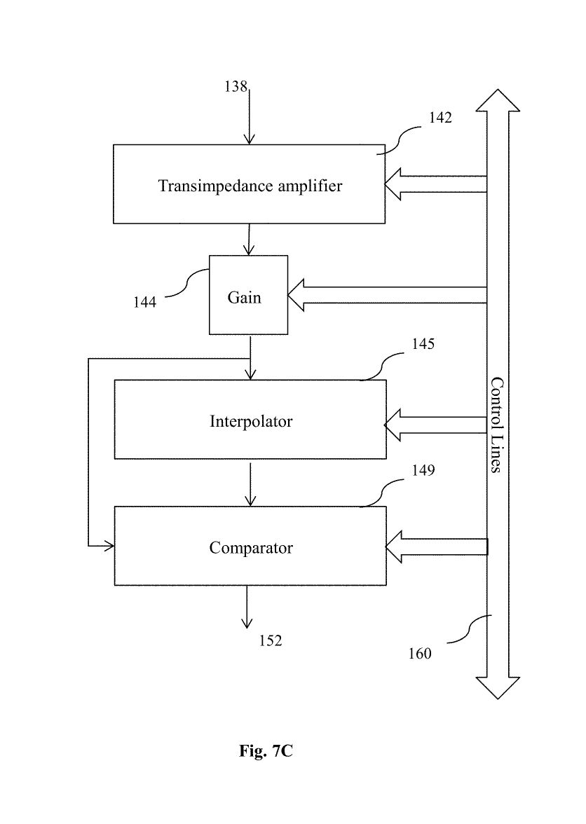

FIG. 7A illustrates a block diagram of a programmable channel 140 in accordance with an embodiment of the present disclosure. Referring to FIG. 7A, the channel 140 includes a transimpedance amplifier (TIA) 142 that receives a current input from the node 138 and converts it into a voltage signal 139. The TIA 142 may be a single ended TIA or a differential TIA, and is sized appropriately for the current input. In an embodiment, The TIAs 142 may be highly linear in order to produce high-quality analog outputs. In another embodiment, the TIAs 142 are logarithmic, in order to accommodate a wide dynamic range of inputs. The transimpedance should be large enough to reduce the angular position error introduced by the amplifier's own internal noise and offset of downstream comparators, yet small enough to preserve good linearity at full-scale input current. Each TIA 142 (in each channel 140) may have an adjustable current sink additive to its input, for offset compensation. The current sink value for a particular instance may be controlled using the control lines 160. The adjustable current sink may include latches to store the control bit(s).

The channel 140 may further include a gain stage amplifier 144 for additional gain. The gain stage amplifier 144 provides further signal amplification or signal conditioning to the voltage signal 139, and produces a voltage signal 141. In an embodiment, the gain stage amplifier 144 is optional and may be turned off or not included in the channel 140. To further such embodiment, the voltage signal 139 feeds to the comparator 146 directly. The gain stage amplifier 144, if present, may be programmed using the control lines 160.

The comparator 146 compares the input voltage signal (141 or 139) to a programmable threshold voltage level, and produces an output 148 (e.g., a binary digital output) to indicate whether the input voltage is higher or lower than the threshold. In some embodiments, the comparator 146 may have multiple programmable threshold voltage levels, for example, to provide multi-level coding rather than binary coding. Further, the comparator 146 may have programmable hysteresis settings (e.g., different crossing points for low-to-high transition and for high-to-low transition) for better noise immunity. The configuration of the comparator 146 (e.g., the settings of the thresholds and hysteresis) works in conjunction with the configuration of the detector array 120 and the detector-to-channel mapping. For example, for a given code disk and a given absolute track, one or multiple columns of detectors 122 may supply electric currents to the channel 140. In the example shown in FIG. 4, the “b₄” channel receives current from one column of detectors 122, while the “b₃” channel receives current from three columns of detectors 122. Accordingly, the comparators in these two channels are programmed with different threshold levels and/or different hysteresis levels in order to encode the bits b₄ and b₃ properly. For example, the comparator 146 in the “b₄” channel is programmed with a lower threshold voltage level than the comparator 146 in the “b₃” channel. The comparator 146 may be programmed using the control lines 160.

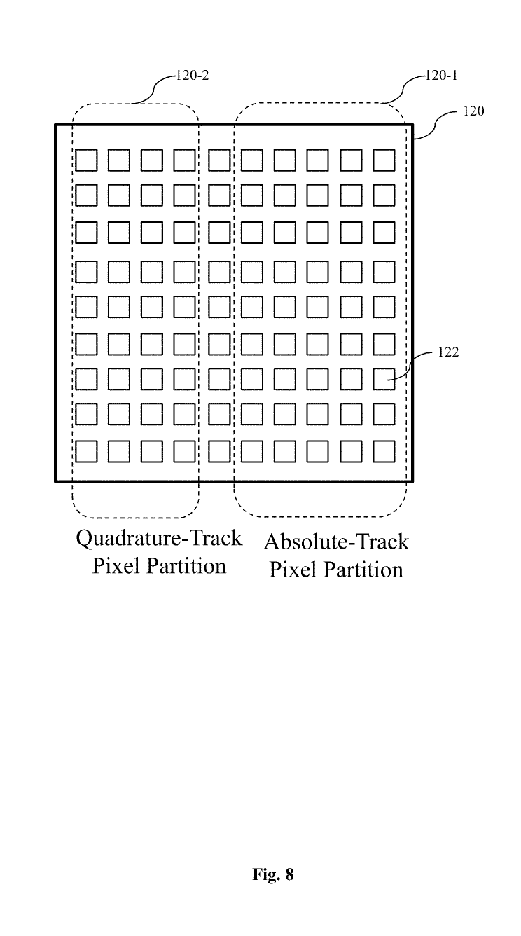

FIG. 7B illustrates a block diagram of a programmable channel 140 in accordance with another embodiment of the present disclosure. Referring to FIG. 7B, the channel 140 includes the TIA 142, the optional gain stage amplifier 144, and the comparator 146 (labeled as “comparator-1”). The functions of the TIA 142, the gain stage amplifier 144, and the comparator-1 146 have been described with respect to FIG. 7A. The channel 140 further includes an interpolator 145 and another comparator 147 (labeled as “comparator-2”). In an embodiment, the interpolator 145 and the comparator 147 are operable to produce codes 150 for an incremental encoder. For example, the detector array 120 may be partitioned to support both an absolute track 108 and a quadrature track 106 simultaneously, as illustrated in FIG. 8. Referring to FIG. 8, some of the columns in the detector array 120 (labeled as a block 120-1) are mapped to an absolute track for encoding positions of the code disk 104, and some of columns in the detector array 120 (labeled as a block 120-2) are mapped to a quadrature track for encoding movements of the code disk 104. In various embodiments, another block of detectors in the detector array 120 (or part of the block 120-1) can be used for index tracking or commutation encoding. The mapping of detectors 122 for absolute encoding has been discussed above. The mapping of detectors for incremental encoding is briefly discussed below.

In an embodiment, the quadrature track 106 includes alternating transmissive and opaque patterns 107 and 109 (see FIGS. 1B and 1C). When the code disk 104 rotates, the light passing through the quadrature track 106 is modulated with a sinusoidal-like waveform with quadrature phases (e.g., 0° (A+), 90° (B+), 180° (A−), and 270° (B−)). These quadrature phases are detected by the detectors in the block 120-2 and may be encoded into an incremental code. In an embodiment, each detector 122 in the block 120-2 can be assigned to any one of the quadrature phases. The assignment can be determined by superimposing part of the quadrature track 106 over the block 120-2, for example, by replacing the absolute track 108 with the quadrature track 106 in FIG. 4. The assignment takes into account of the quadrature track 106's radius and PPR, and the detector block 120-2's shape, number of detectors, detector spacing, and so on. The assignment may be stored in a memory module, such as a non-volatile memory, and accessible by the encoder system 100.

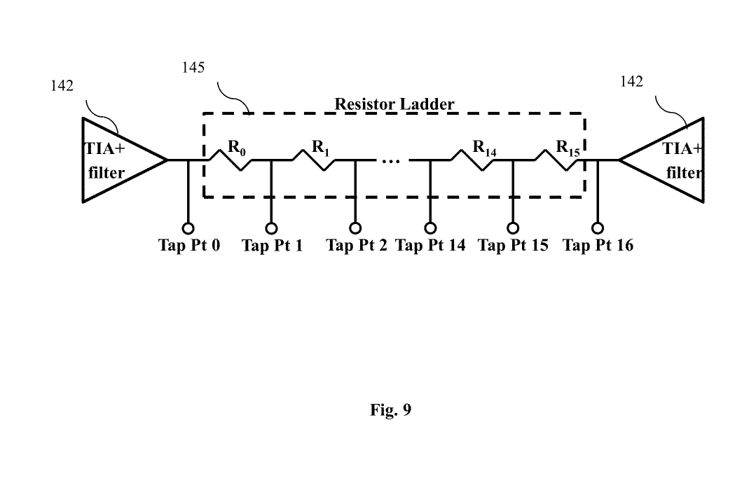

FIG. 9 shows a circuit diagram of an example interpolator 145 with resistor ladder architecture, working in conjunction with the TIAs 142 to provide incremental coding. This is merely an example. Other suitable implementations, such as other suitable number of interpolator resistors (≥2) and/or other suitable circuit topology may also be used. In the illustrated embodiment, the interpolator 145 generates analog waveforms that are phase-shifted from the filtered TIA output waveforms between 0° and 90° in equal steps of 5.625° (=90°/16). By digitally comparing appropriate interpolated waveforms (e.g., using the comparator 147 of FIG. 7B), square waves of up to 16× the frequency of the TIA outputs can be generated for this example embodiment. In an example implementation, the encoder device 110 includes four identical resistor ladders, each between the filtered TIA outputs of two of the four quadrature phases A+, A−, B+, and B−. For example, a first one between the B+ and A− filtered TIA outputs, a second one between the A− and B− filtered TIA outputs, a third one between the B− and A+ filtered TIA outputs, and a fourth one between the A+ and B+ filtered TIA outputs. Various other embodiments may be scaled as appropriate to provide any number of steps.

FIG. 7C illustrates a block diagram of a programmable channel 140 in accordance with yet another embodiment of the present disclosure. Referring to FIG. 7C, the channel 140 includes the TIA 142, the optional gain stage amplifier 144, the interpolator 145, and a comparator 149. The comparator 149 may perform the functions of the comparator 146 or those of the comparator 147, depending on the configuration supplied from the control lines 160. In other words, the comparator 149 is shared by an absolute encoder and an incremental encoder. Accordingly, the outputs 152 may be an absolute code or an incremental code. When the comparator 149 is used for incremental encoding, it takes inputs from the interpolator 145. Otherwise, its takes inputs from the gain stage amplifier 144 or from the TIA 142. This architecture simplifies the design of the channels 140.

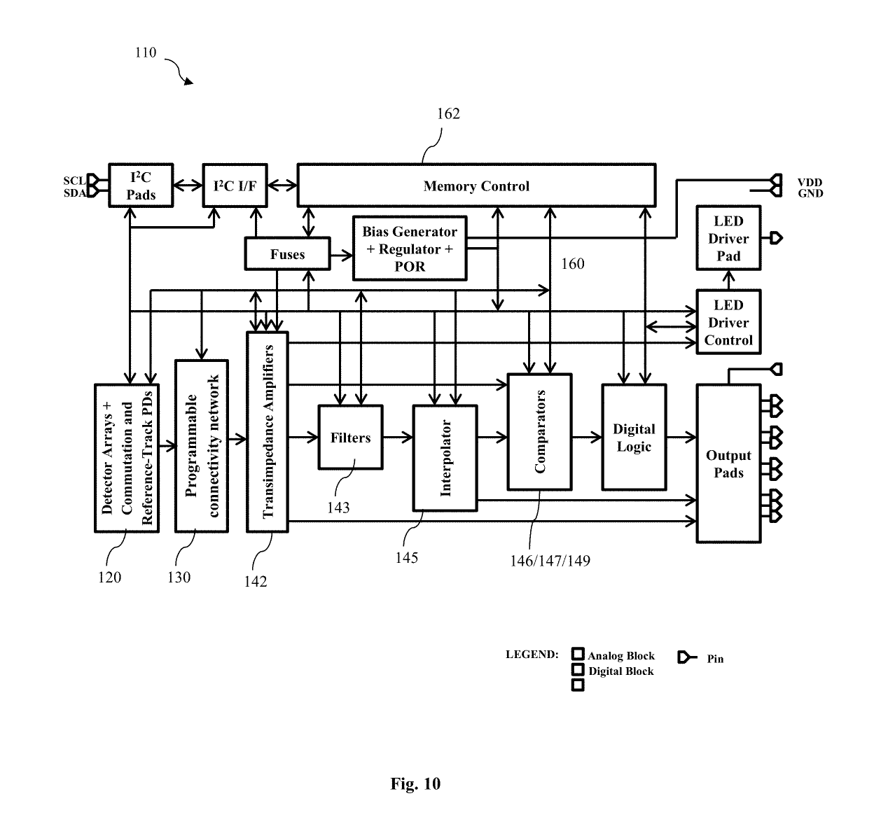

FIG. 10 illustrates a block diagram of an example encoder device 110. Some of the components of the encoder device 110 have been discussed above, including the programmable detector array 120, the programmable connectivity network 130, the transimpedance amplifiers 142, the interpolators 145, and the comparators 146, 147, and 149. The encoder device 110 may optionally contain a filter 143 to remove harmonics introduced by the non-ideal mapping of pixels to code disk slits. If present, the filter 143 is coupled between the TIA 142 and the interpolator 145. The filter 143 may also be configurable to adapt to different operating speeds of the code disk 104. The encoder device 110 further includes output drivers and power supply. The output drivers may support either digital or analog outputs or both digital and analog outputs.

The encoder device 110 may also provide current control for the companion light source 102 (e.g., an LED), either driving at a constant current over voltage/temperature or using feedback to provide a constant optical power density. Either the encoder device 110 or a discrete detector may be used to monitor this feedback. For example, one or more rows or columns of the detectors 122 in the detector array 120 may serve as the feedback mechanism. The encoder device 110 may further include components (not shown) for dithering detectors (pixels) during run time. Normally detectors are set to a static configuration at startup. Having the ability to shift a detector from one channel to another or to off, may allow increased performance particularly at low rotation speeds. Furthermore, a combination of detector dithering and LED current drive control may provide improvement in detection of small changes in the positions or movements of the code disk 104.

The configuration associated with the programmable detector array 120, the programmable connectivity network 130, and the programmable channels 140 may be accessed either from a random-access memory (RAM) or from a non-volatile memory (NVM). In the case of RAM, a host microcontroller may set each memory bits (or register bits) in the encoder device 110 using I²C, Serial Peripheral Interface (SPI) bus, a parallel memory bus, or other suitable memory interfaces. Alternatively, the encoder device 110 may contain logic (memory controller 162 in FIG. 10) to read from an external NVM or an internal NVM and set the memory bits accordingly. Internal NVM may be programmable—i.e., flash memory or any reprogrammable memory, one-time-programmable memory (e.g., e-fuses), or read-only memory (ROM).

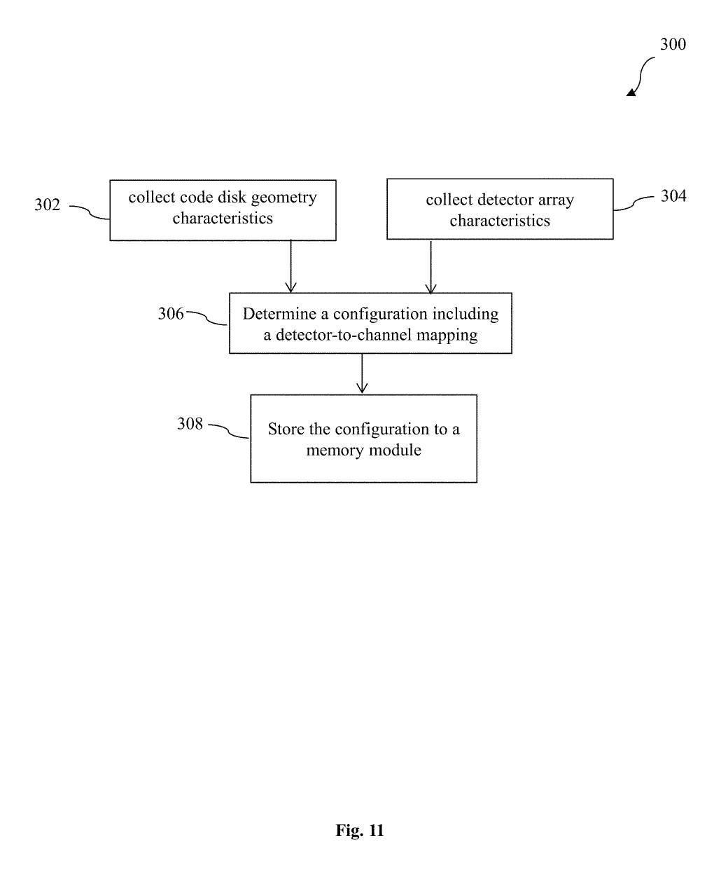

FIG. 11 shows a flow chart of an example method 300 to determine a configuration for programming the detector array 120, the connectivity network 130, and the channels 140. A physically separate computer system (e.g., a PC) and/or other microcontroller unit(s) may execute the operations of method 300 by reading code from a computer-readable medium and executing that code to provide the functionality discussed herein. In an example embodiment, method 300 is executed by a standalone computer system (e.g., a PC) during a manufacturing operation, rather than by the microcontroller unit in the encoder device 100 or during the encoder's run time. The method 300 includes an operation 302 for collecting geometric characteristics of the code disk 104; an operation 304 for collecting geometric characteristics of the detector array 120; an operation 306 for determining a configuration of the encoder device 110 including a grouping of detectors 122 (e.g., based on regions, row, or columns), a detector-to-channel mapping, and settings of various components in the channels 140; and an operation 308 for storing the configuration into a memory module. The operations 302, 304, 306, and 308 are further discussed below.

At operation 302, code disk geometry characteristics are collected from the setup of the code disk 104, which may be stored in a memory. The code disk geometry characteristics may include disk radii, PPR or pulse-per-length, rotation/sliding speed, geometries of the patterns 107 and 109, the sequence of the patterns 107 and 109 on the absolute track 108, and so on.

At operation 304, detector array characteristics are collected from the setup of the detector array 120, which may be stored in a memory. The detector array characteristics include array dimensions (e.g., number of rows, number of columns), detector spacing, detector shape, and detector size. In an embodiment, the detector array characteristics may include X-/Y-direction misalignment information.

At operation 306, the method 300 determines a configuration. For example, the operation 306 may superimpose the patterns 107 and 109 of the absolute track 108 over a block of the detectors 122 (e.g., FIG. 4) and determine which detector(s) should be turned ON, OFF, or partially ON, and further determine which detectors should be assigned to which channel(s). The operation 306 may calculate a fitting score for a particular mapping, for example, based on how closely the detectors match the geometries of the patterns 107 and 109 (mathematically or by simulation) or how low the encoding error probability is (by simulation). The operation 306 may repeat this process with different segments of the absolute track 108 superimposed on the block of the detectors 122, and choose a mapping that bears the highest fitting score or is better than a user-selectable threshold. The operation 306 may also determine the settings in various components in the channels 140, including the threshold and hysteresis for the comparators 146. In an embodiment where the detector device 110 supports both absolute encoding and incremental encoding, the operation 306 may determine the configuration for both.

At operation 308, the method 300 stores the configuration to a memory module, such as a memory module in the encoder device 110 or a memory module outside of the encoder device 110.

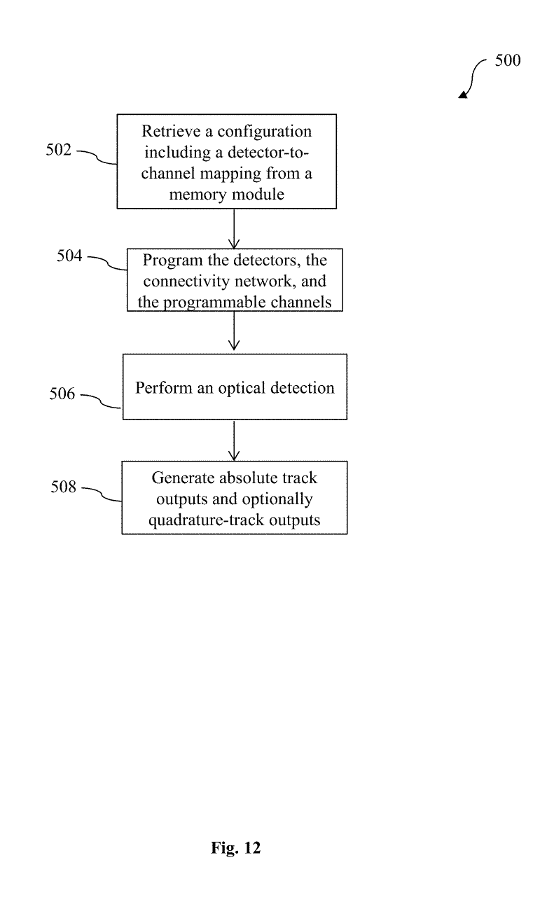

FIG. 12 shows a flow chart of an example method 500 of operating an encoder system 100, particularly the encoder device 110 with programmable detector array, programmable connectivity network, and programmable channels. A microcontroller or other processor may execute the operations of method 500 by reading code from a computer-readable medium and executing that code to provide the functionality discussed herein.

At operation 502, the encoder device 110 retrieves a configuration from a memory module after power up. The configuration includes state assignments (ON, OFF, partially ON) of the detectors 122, track assignments of the detectors 122 (quadrature track or absolute track), channel assignments of the detectors 122, threshold levels of the comparators 146, and various other settings of the encoder device 110. In an embodiment, the encoder device 110 may run an internal state machine (e.g., using the memory control 162 of FIG. 10) that reads an external non-volatile memory to load the configuration.

At operation 504, each detector 122 in the detector array 120 is programmed to a state defined in the configuration, and is assigned to a proper channel (either a quadrature channel or an absolute channel). The connectivity network 130 is properly programmed using the detector-to-channel mapping. The channels 140 are programmed with proper threshold levels, hysteresis, or other settings. The programming may be implemented with register bits in the detector device 110.

At operation 506, the detector device 110 performs an optical detection, by collecting currents from different assigned regions on the detector array 120 in response to light modulated by a code disk 104, which may be rotary or linear, and may be transmissive or reflective. At operation 508, the detector device 110 generates digital or analog outputs for encoding the absolute position of the code disk 104 (using the absolute track 108) and optionally for encoding the movement of the code disk 104 (using the quadrature track 106).

Although not intended to be limiting, one or more embodiments of the present disclosure provide many benefits to an optical encoder using programmable detector array. Most conventional optical encoder designs use a fixed pattern phased array to match a particular code disk, thus preventing the use of the same detector design to other code disks. In contrast, the detector device in various embodiments of the present disclosure may be programmed to work with a variety of code disks, greatly increasing design flexibility and lowering the costs associated with the detector device. The detector device may be programmed by a host microcontroller, by the detector device itself using an internal non-volatile memory with a built-in circuit, or by using a masked ROM where the configuration are set in factory. Furthermore, in-system configurability is possible for some embodiments. Encoder manufacturers may apply a patch in the field, updating the configuration after the product has been installed in the field. Still further, the lack of a visible phased-array pattern makes the design less susceptible to copying by competitors.

Moreover, the programmable detector arrays may also allow a customer to use the same detector device to develop a product portfolio of difference performance levels. Therefore, encoder manufacturers may provide different performance/price points with a common set of hardware, allowing them to market their products differently.

In one exemplary aspect, the present disclosure is directed to an encoder system. The encoder system includes a group of programmable detectors, each of the programmable detectors operable to produce an electric current in response to an optical or magnetic input. The encoder system further includes a group of programmable channels, each of the programmable channels operable to produce an output in response to an electric current input, the outputs from the programmable channels forming at least a part of a code word for determining an absolute position of a motion object. The encoder system further includes a programmable connectivity network coupled between the programmable detectors and the programmable channels and operable to route electric currents from at least a part of the programmable detectors to each of the programmable channels.

In an embodiment of the encoder system, each of the programmable channels includes a comparator with a programmable threshold level. In a further embodiment, each of the programmable channels includes a transimpedance amplifier coupled between the comparator and the programmable connectivity network, wherein the transimpedance amplifier receives electric currents from the programmable detectors. In another further embodiment, the comparator also has a programmable hysteresis.

In an embodiment of the encoder system, each of the programmable detectors is operable to be set to one of states including: OFF, partially ON, and fully ON. In another embodiment, the programmable detectors are arranged into an array with rows and columns. In a further embodiment, the programmable detectors in a same column are routed to a same programmable channel. In yet another embodiment, at least one of the programmable detectors in a column is programmed to be OFF while other ones of the programmable detectors in the column are programmed to be ON.

In another embodiment, the encoder system further includes an incremental encoding channel whose outputs are operable to determine a relative position of the motion object, wherein the programmable connectivity network is operable to route electric currents from some of the programmable detectors to the incremental encoding channel. In a further embodiment, the programmable detectors supplying electric currents to the incremental encoding channel are separate from the programmable detectors supplying electric currents to the programmable channels.

In yet another embodiment, the encoder system further includes a controller operable to read one or more configuration files from one or more memories and to program the programmable detectors, the programmable channels, and the programmable connectivity network using the one or more configuration files.

In another exemplary aspect, the present disclosure is directed to an encoder system. The encoder system includes a transmitter operable to transmit an electromagnetic wave; a code disk operable to modulate the electromagnetic wave with a pattern, resulting in a modulated electromagnetic wave; and a receiver operable to receive the modulated electromagnetic wave and to detect at least absolute positions of the code disk. The receiver includes programmable detectors, each of the programmable detectors operable to produce an electric current in response to the modulated electromagnetic wave incident thereon. The receiver further includes programmable channels, each of the programmable channels operable to produce an output in response to an electric current input, the outputs from the programmable channels forming at least a part of a code word for determining the absolute positions of the code disk. The receiver further includes a programmable connectivity network coupled between the programmable detectors and the programmable channels and operable to route electric currents from at least a part of the programmable detectors to each of the programmable channels. The receiver is operable to receive one or more configuration files and to program the programmable detectors, the programmable channels, and the programmable connectivity network using the one or more configuration files.

In an embodiment of the encoder system, each of the programmable channels includes a comparator with a programmable threshold voltage level. In an embodiment of the encoder system, the programmable detectors are arranged in multiple columns, wherein the programmable detectors on a same column are routed to a same programmable channel through the programmable connectivity network. In a further embodiment, the programmable connectivity network is operable to route one column of the programmable detectors to multiple ones of the programmable channels. In yet another embodiment of the encoder system, the receiver is further operable to detect a motion of the code disk.

In yet another exemplary aspect, the present disclosure is directed to an encoder system. The encoder system includes an array of optical detectors. Each of the optical detectors is operable to be programmed into one of states that include ON and OFF, wherein an optical detector in the ON state is operable to produce an electric current in response to a light incident thereon. The encoder system further includes a group of channels. Each of the channels is operable to produce an output in response to an electric current input, the outputs from the channels forming at least a part of a code word for determining absolute positions of a motion object. Each of the channels includes a voltage comparator with a programmable threshold. The encoder system further includes a programmable connectivity network coupled between the optical detectors and the channels and operable to route electric currents from the optical detectors to the channels. The programmable connectivity network is operable to route one column of the optical detectors to multiple channels and to route multiple columns of the optical detectors to one channel.

In an embodiment of the encoder system, each of the channels further includes a transimpedance amplifier coupled between the voltage comparator and the programmable connectivity network. In an embodiment of the encoder system, two of the channels are programmed to receive electric currents from different numbers of the optical detectors. In a further embodiment, the comparators in the two of the channels are programmed with different thresholds.

In yet another exemplary aspect, the present disclosure is directed to a method. The method includes retrieving a configuration including a detector-to-channel mapping from a memory module; programming a detector device having an array of programmable detectors, a programmable connectivity network, and programmable channels using the configuration; performing an optical detection with the detector device and a code disk having an absolute track; and generating codes corresponding to absolute positions of the code disk. In an embodiment, performing the optical detection includes providing a light source; projecting light from the light source to the absolute track; and using the detector device, receiving light transmitted through or reflected by the absolute track. In an embodiment, the method further includes collecting code disk geometries; collecting characteristics of an array of programmable detectors; determining a configuration of the array of programmable detectors based on the code disk geometries, wherein the configuration includes a detector-to-channel mapping; and storing the configuration into a memory module. In some embodiments, determining the configuration further includes determining thresholds for programmable comparators in the programmable channels of the detector device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An encoder system, comprising:
a group of programmable detectors, each of the programmable detectors operable to produce an electric current in response to an optical or magnetic input;
a group of programmable channels, each of the programmable channels operable to produce an output in response to an electric current input, the outputs from the programmable channels forming at least a part of a code word for determining an absolute position of a motion object; and
a programmable connectivity network coupled between the programmable detectors and the programmable channels and operable to route electric currents from at least a part of the programmable detectors to each of the programmable channels.

2. The encoder system of claim 1, wherein each of the programmable channels includes a comparator with a programmable threshold level.

3. The encoder system of claim 2, wherein each of the programmable channels includes a transimpedance amplifier coupled between the comparator and the programmable connectivity network, wherein the transimpedance amplifier receives electric currents from the programmable detectors.

4. The encoder system of claim 2, wherein the comparator comprises a programmable hysteresis.

5. The encoder system of claim 1, wherein each of the programmable detectors is operable to be set to one of states including: OFF, partially ON, and fully ON.

6. The encoder system of claim 1, wherein the programmable detectors are arranged into an array with rows and columns.

7. The encoder system of claim 6, wherein the programmable detectors in a same column are routed to a same programmable channel.

8. The encoder system of claim 7, wherein at least one of the programmable detectors in a column is programmed to be OFF while other ones of the programmable detectors in the column are programmed to be ON.

9. The encoder system of claim 1, further comprising an incremental encoding channel whose outputs are operable to determine a relative position of the motion object, wherein the programmable connectivity network is operable to route electric currents from some of the programmable detectors to the incremental encoding channel.

10. The encoder system of claim 9, wherein the programmable detectors supplying electric currents to the incremental encoding channel are separate from the programmable detectors supplying electric currents to the programmable channels.

11. The encoder system of claim 1, further comprising:
a controller operable to read one or more configuration files from one or more memories and to program the programmable detectors, the programmable channels, and the programmable connectivity network using the one or more configuration files.

12. An encoder system, comprising:
a transmitter operable to transmit an electromagnetic wave;
a code disk operable to modulate the electromagnetic wave with a pattern, resulting in a modulated electromagnetic wave; and
a receiver operable to receive the modulated electromagnetic wave and to detect absolute positions of the code disk,
wherein the receiver includes:
programmable detectors, each of the programmable detectors operable to produce an electric current in response to the modulated electromagnetic wave incident thereon;
programmable channels, each of the programmable channels operable to produce an output in response to an electric current input, the outputs from the programmable channels forming at least a part of a code word for determining the absolute positions of the code disk; and
a programmable connectivity network coupled between the programmable detectors and the programmable channels and operable to route electric currents from at least a part of the programmable detectors to each of the programmable channels,
wherein the receiver is operable to receive one or more configuration files and to program the programmable detectors, the programmable channels, and the programmable connectivity network using the one or more configuration files.

13. The encoder system of claim 12, wherein each of the programmable channels includes a comparator with a programmable threshold voltage level.

14. The encoder system of claim 12, wherein the programmable detectors are arranged in multiple columns, wherein the programmable detectors on a same column are routed to a same programmable channel through the programmable connectivity network.

15. The encoder system of claim 14, wherein the programmable connectivity network is operable to route one column of the programmable detectors to multiple ones of the programmable channels.

16. The encoder system of claim 12, wherein the receiver is further operable to detect a motion of the code disk.

17. An encoder system, comprising:
an array of optical detectors, each of the optical detectors operable to be programmed into one of states that include ON and OFF, wherein an optical detector in the ON state is operable to produce an electric current in response to a light incident thereon;
a group of channels, each of the channels operable to produce an output in response to an electric current input, the outputs from the channels forming at least a part of a code word for determining absolute positions of a motion object, wherein each of the channels includes a voltage comparator with a programmable threshold; and
a programmable connectivity network coupled between the optical detectors and the channels and operable to route electric currents from the optical detectors to the channels, wherein the programmable connectivity network is operable to route one column of the optical detectors to multiple channels and to route multiple columns of the optical detectors to one channel.

18. The encoder system of claim 17, wherein each of the channels further includes a transimpedance amplifier coupled between the voltage comparator and the programmable connectivity network.

19. The encoder system of claim 17, wherein two of the channels are programmed to receive electric currents from different numbers of the optical detectors.

20. The encoder system of claim 19, wherein the comparators in the two of the channels are programmed with different thresholds.
